(19) United States
(12) Patent Application Publication
(10) Pub. No.: US 2008/0092217 A1
(43) Pub. Date: Apr. 17, 2008

(54) ENVIRONMENT MIGRATION SYSTEM, TERMINAL APPARATUS, INFORMATION PROCESSING APPARATUS, MANAGEMENT SERVER, AND PORTABLE STORAGE MEDIUM

(76) Inventors: Akihisa NAGAMI, Yokohama (JP); Yukinobu MIZOGUCHI, Odawara (JP); Fumio Noda, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/863,721

(22) Filed: Sep. 28, 2007

(30) Foreign Application Priority Data
Sep. 29, 2006 (JP) 2006-268969

(51) Int. Cl. H04L 9/32

(52) U.S. Cl. 726/5

(57) ABSTRACT

An environment migration system set, as a utilization environment of a terminal, a utilization environment of another terminal in an information processing apparatus when the terminal utilizes the information processing apparatus through a network. A connection is established through a network between the information processing apparatus and the other terminal in accordance with response data returned from the information processing apparatus. A utilization environment transmitting unit extracts data of the utilization environment of the other terminal and transmits it to the address of the information processing apparatus. The utilization environment data received from the other terminal is then stored into a storage apparatus as the utilization environment data of the terminal.

### CROSS-REFERENCE TO RELATED APPLICATIONS

The present application claims a priority from Japanese Patent Application No. 2006-268969 filed on Sep. 29, 2006, the content of which herein incorporated by reference.

### BACKGROUND OF THE INVENTION

The present invention relates generally to an environment migration system, a terminal apparatus, an information processing apparatus, a management server, and a portable storage medium and, more particularly, to an environment migration technology that realizes an environment utilized in a non-security PC when utilizing a security PC in a thin client system.

Due to needs of countermeasure for information leaks and internal control in companies, etc., a concept of thin client appears where a dedicated computer (thin client) having no hard disk apparatus, etc., and having only minimum functions such as displaying and inputting is employed as a client computer to unify the management of resources such as application software in a server (blade server).

With regard to technologies related to such a thin client system, for example, for the purpose of providing a secure remote access system which improves user-friendliness by using a storage device having a built-in tamper-proof device as a user authentication device in the secure remote access system in which a user accesses a server while performing encrypted communication from an indefinite client, thereby performing a task, a remote access system has been proposed that includes a server, a client device accessing the server, a network connecting the server and the client device, a remote control application program connected to the client device to remotely control the server, an encryption application program encrypting communications over the network, and a storage medium having a business application and authentication information stored in a tamper-proof region for the remote control of the server; the storage medium has middleware stored thereon to drive the remote control application, the encryption application, and the business application to be operated on the client device; and the CPU of the client device executes the middleware to operate a file access application interface and a file access driver when performing file access and to operate an interface handler and a device driver for communication between the sever and the client device when performing an authentication process. See, for example, Japanese Patent Application Laid-Open Publication No. 2005-235159.

For the purpose of constructing a computer system capable of always executing processing in the same environment without depending on a terminal device directly used by a user, that is, without depending on a place or an appliance of a client used by the user, a computer system has been proposed that includes a computer apparatus having a plurality of computer boards, a storage apparatus connected to the computer apparatus through a network and having a plurality of storage areas, a management computer that manages the computer apparatus and the storage apparatus, and a terminal apparatus connected to the management computer through a network; the management computer includes a first table defining a correlation between user information and the storage areas; if a utilization request for the computer board including user information is transmitted from the terminal apparatus, the management computer selects an unutilized computer board among the plurality of computer boards, sends back an available computer board number to the terminal apparatus, assigns a storage area corresponding to the user information based on the first table, and transmits an address identifying the storage area to the computer apparatus. See, for example, Japanese Patent Application Laid-Open Publication No. 2005-327233.

For the purpose of improving security of a storage apparatus, an apparatus has been proposed that includes a flash memory chip, an IC card chip capable of executing a security process (such as encryption and decryption), and a controller chip that controls reading/writing of data from/to the flash memory chip and the IC card chip in accordance with a request from a host. See, for example, PCT International Patent Publication No. WO02/099742A1.

### SUMMARY OF THE INVENTION

By the way, when utilizing a blade server with a thin client, a utilization environment of a thin client user must be set in the blade server in advance. That is, the thin client user must send to the blade server, for example, an address book of e-mail software, utilization setting for each application such as a sorting rule of transmission/reception e-mails, and various files created by the thin client user in a conventionally utilized non-security PC (a common PC). Therefore, conventionally, it is required to concurrently prepare the non-security PC and the security PC, i.e., the thin client to perform an environment migration process.

Therefore, appropriate files must be selected from the non-security PC and moved to the thin client, which requires time and effort. An area for the non-security PC and an area for the thin client must individually be prepared in the blade server for the environment migration.

The present invention was conceived in view of the above problems and therefore the present invention primarily provides a technology that realizes a migration process ensuring efficient and good security when a utilization environment of a non-security PC is migrated as a utilization environment of a thin client.

According to a first aspect of the present invention there is provided an environment migration system setting as a utilization environment of a terminal a utilization environment of another terminal in an information processing apparatus when the terminal utilizes the information processing apparatus through a network, the another terminal including an address acquiring unit that reads storage information of a portable storage medium used by a person who will be a user of the terminal, the address acquiring unit acquiring an address of the information processing apparatus that is a destination of utilization allocation of the terminal included in the storage information to store the data of the address into a memory; a connection establishing unit that transmits a connection establishment request including at least authentication information of the terminal or the user to the address of the information processing apparatus stored in the memory, the connection establishing unit executing a connection establishment process through a network between the information processing apparatus and the another terminal in accordance with response data returned from the information processing apparatus in response to the connection establishment request; and a utilization environment transmitting unit that extracts data of the utilization environment of the another terminal in accordance with the execution of the connection establishment process to transmit the utilization environment data to the address of the information processing apparatus, the information processing apparatus including a connection management table that stores the authentication information of the terminal or the user allocated to the information processing apparatus for utilization; an establishment determining unit that receives the connection establishment request transmitted from the another terminal, the establishment determining unit checking the authentication information of the terminal or user included in the connection establishment request against the connection management table to determine whether the connection establishment request can be accepted, and the establishment determining unit sending back the determination result as response data to the another terminal; and an environment setting unit that receives utilization environment data from the another terminal to store the utilization environment data into a storage apparatus as the utilization environment data of the terminal as the connection establishment process is executed for the another terminal in accordance with the determination result.

According to the present invention, when a utilization environment of a non-security PC is migrated as a utilization environment of a thin client, a migration process ensuring efficient and good security can be realized.

The another terminal may include an authentication information acquiring unit that acquires the storage information of the portable storage medium, including an address of a management server executing a utilization allocation process between the terminal and the information processing apparatus, from a reader of the portable storage medium to store the information into an appropriate memory, a utilization allocation request transmitting unit that includes and transmits the storage information of the portable storage medium read from the memory in a utilization allocation request for the information processing apparatus to the address of the management server read from the memory, and an address storage processing unit that receives from the management server the address of the information processing apparatus that should be allocated to the terminal to store the address of the information processing apparatus into the portable storage medium; and the management server may include an allocation management table that stores a correlation between the storage information of the portable storage medium used by each user of the terminal and the address of the information processing apparatus that is a destination of utilization allocation of the terminal linked to the portable storage medium, and an address notifying unit that receives from the another terminal a utilization allocation request including the storage information of the portable storage medium, that checks the storage information of the portable storage medium included in the utilization allocation request against the allocation management table to identify the address of the information processing apparatus, and that supplies the address to the another terminal that is the source of the utilization allocation request.

This enables the portable storage medium to acquire an address of a blade server (information processing apparatus) from the management server through another terminal that is a non-security PC.

The portable storage medium may include an authentication information acquiring unit that acquires and stores the storage information of the portable storage medium into an appropriate memory of the portable storage medium itself or the another terminal, a management server address storage unit that has stored thereon the address of the management server that executes a utilization allocation process between the terminal and the information processing apparatus, a utilization allocation request transmitting unit that includes and transmits the storage information of the portable storage medium read from the memory in a utilization allocation request for the information processing apparatus to the address of the management server stored in the management server address storage unit through the another terminal, and an address storage processing unit that receives the address of the information processing apparatus that should be allocated to the terminal transmitted from the management server to store the address of the information processing apparatus into the own appropriate memory of the portable storage medium; and the another terminal may include a transmitting/receiving unit that transmits output data of the utilization allocation request transmitting unit of the portable storage medium through the network to the management server and that sends back the address of the information processing apparatus sent from the management server to the address storage processing unit of the portable storage medium.

By virtue of this, the portable storage medium can mainly execute the environment migration process, which excels in convenience (e.g., all that is basically required is to connect the portable storage medium to other terminal) and security (e.g., an execution program can be stored in the portable storage medium that can readily ensure security) as compared to situations where other terminal mainly executes the environment migration process.

The management server may have a program stored in a storage apparatus including functions of the authentication information acquiring unit, the utilization allocation request transmitting unit, and the address storage processing unit; and the portable storage medium may include the management server address storage unit, a program acquisition requesting unit that extracts the address of the management server from the management server address storage unit to transmit an acquisition request for the program to this address, and a program acquiring unit that downloads the program from the management server in accordance with the acquisition request for the program to store the program into a memory of the portable storage medium itself or the another terminal.

This enables an application executing the environment migration process to be acquired from the management server, which reduces the effort and storage capacity to store a program in the portable storage medium in advance.

The information processing apparatus may include a biometrics authentication information storage unit that stores biometrics authentication information of a user of a terminal allocated to the information processing apparatus for utilization; and the establishment determining unit may check biological information of the user included in a connection establishment request received from the another terminal against the biometrics authentication information storage unit to determine whether the connection establishment request can be accepted and send back the determination result as response data to the another terminal.

This enables good security to be maintained when coupling another terminal that is a non-security PC and the information processing apparatus.

According to a second aspect of the present invention there is provided a terminal apparatus coupled to an information processing apparatus through a network to set its own utilization environment as a utilization environment of another terminal in the information processing apparatus, comprising an address acquiring unit that reads storage information of a portable storage medium used by a person who will be a user of the terminal, the address acquiring unit acquiring an address of the information processing apparatus that is a destination of utilization allocation of the terminal included in the storage information to store the data of the address into a memory; a connection establishing unit that transmits a connection establishment request including at least authentication information of the terminal or the user to the address of the information processing apparatus stored in the memory, the connection establishing unit executing a connection establishment process through a network between the information processing apparatus and the terminal apparatus in accordance with response data returned from the information processing apparatus in response to the connection establishment request; and a utilization environment transmitting unit that extracts data of the utilization environment of the terminal apparatus in accordance with the execution of the connection establishment process to transmit the utilization environment data to the address of the information processing apparatus.

According to the present invention, when a utilization environment of a non-security PC is migrated as a utilization environment of a thin client, a migration process ensuring efficient and good security can be realized with the portable storage medium and the information processing apparatus.

According to a third aspect of the present invention there is provided an information processing apparatus that stores a utilization environment of a terminal apparatus coupled through a network as a utilization environment of another terminal, comprising a connection management table that stores authentication information of a terminal or user allocated to the information processing apparatus for utilization; an establishment determining unit that receives a connection establishment request transmitted from the terminal apparatus, the establishment determining unit checking the authentication information of the terminal or user included in the connection establishment request against the connection management table to determine whether the connection establishment request can be accepted, and the establishment determining unit sending back the determination result as response data to the terminal apparatus; and an environment setting unit that receives utilization environment data from the terminal apparatus to store the utilization environment data into a storage apparatus as the utilization environment data of the terminal as the connection establishment process is executed for the terminal apparatus in accordance with the determination result.

According to the present invention, when a utilization environment of a non-security PC is migrated as a utilization environment of a thin client, a migration process ensuring efficient and good security can be realized with a terminal apparatus (other terminal) and the portable storage medium.

According to a fourth aspect of the present invention there is provided a management server coupled through a network to an information processing apparatus and a terminal apparatus using the apparatus, comprising an allocation management table that stores a correlation between the storage information of the portable storage medium used by each user of the terminal and the address of the information processing apparatus that is a destination of utilization allocation of the terminal linked to the portable storage medium; and an address notifying unit that receives from the terminal apparatus a utilization allocation request including the storage information of the portable storage medium, the address notifying unit checking the storage information of the portable storage medium included in the utilization allocation request against the allocation management table to identify the address of the information processing apparatus, and the address notifying unit supplying the address to the terminal apparatus that is the source of the utilization allocation request.

According to the present invention, when a utilization environment of a non-security PC is migrated as a utilization environment of a thin client, a migration process ensuring efficient and good security can be realized with a terminal apparatus (other terminal), the portable storage medium, and the information processing apparatus.

According to a fifth aspect of the present invention there is provided a portable storage medium coupled to an information processing apparatus through a terminal apparatus to set a utilization environment of the terminal apparatus as a utilization environment of another terminal in an information processing apparatus, comprising an authentication information acquiring unit that acquires and stores the storage information of the portable storage medium into an appropriate memory of the portable storage medium itself or the terminal apparatus; a management server address storage unit that has stored thereon an address of a management server that executes a utilization allocation process between the terminal and the information processing apparatus; a utilization allocation request transmitting unit that includes and transmits the storage information of the portable storage medium read from the memory in a utilization allocation request for the information processing apparatus to the address of the management server stored in the management server address storage unit; and an address storage processing unit that receives an address of the information processing apparatus that should be allocated to the terminal from the management server to store the address of the information processing apparatus into the own appropriate memory of the portable storage medium.

According to the present invention, when a utilization environment of a non-security PC is migrated as a utilization environment of a thin client, a migration process ensuring efficient and good security can be realized with a terminal apparatus (other terminal) and the information processing apparatus.

Other problems and solutions disclosed in this application will become apparent from the following description of the embodiments of the present invention and the accompanying drawings.

### BRIEF DESCRIPTION OF THE DRAWINGS

FIG. 1 is a network configuration view of an environment migration system of an embodiment;

FIG. 2 depicts an exemplary configuration of a management server of an embodiment;

FIG. 3 depicts an exemplary configuration of a thin client that is a terminal of an embodiment;

FIG. 4 depicts an exemplary configuration of a non-security PC that is other terminal of an embodiment;

FIG. 5 depicts an exemplary configuration of a blade server that is an information processing apparatus of an embodiment;

FIG. 6 depicts an exemplary configuration of an IC chip included in a portable storage medium of an embodiment;

FIG. 7A depicts an exemplary data configuration of an allocation management table in an embodiment;

FIG. 7B depicts an exemplary data configuration of a connection management table in an embodiment;

FIG. 8 depicts a first process flow example of an environment migrating method in an embodiment;

FIG. 9 depicts a second process flow example of the environment migrating method in an embodiment;

FIG. 10 depicts a third process flow example of the environment migrating method in an embodiment; and

FIG. 11 depicts a fourth process flow example of the environment migrating method in an embodiment.

### DETAILED DESCRIPTION OF THE EMBODIMENTS

—System Configuration—

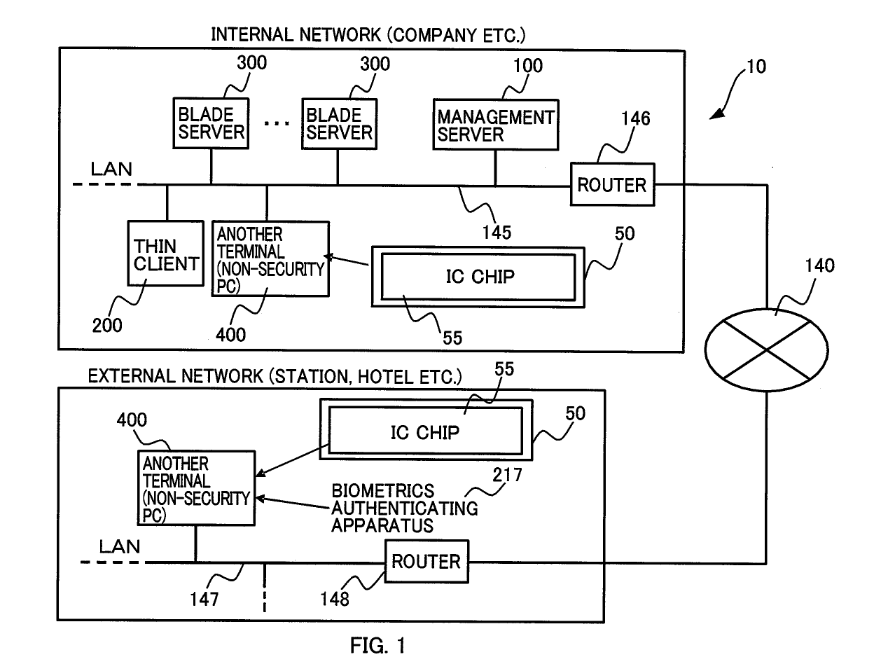

One embodiment of the present invention will hereinafter be described in detail with reference to the drawings. FIG. 1 is a network configuration view of an environment migration system of the embodiment. An environment migration system 10 shown in FIG. 1 is a system including a plurality of information processing apparatuses 300, a management server 100 that manages the information processing apparatuses 300, and another terminal 400, which are coupled to each other through a network 140, and for example, it can be assumed that the information processing apparatus is a blade server 300 and that the another terminal 400 is a normal PC, which is a non-security PC. A thin client 200 is a terminal 200 that sets and utilizes a utilization environment in the another terminal 400 in the blade server 300. The management server 100, the blade server 300, and the another terminal 400 are coupled to LAN (Local Area Network) 145, which is an internal network established in a company, etc. The LAN 145 is coupled to the network 140 such as WAN (Wide Area Network) through a router 146. It can be assumed that the another terminal 400 is utilized when coupled to an external network established in outside locations such as hotels and stations, instead of the internal network (company, etc.) in some situations. In this case, the another terminal 400 is coupled to LAN 147 that is an external network, and is coupled through a router 148 to the network 140 such as WAN.

The blade server 300 establishes VPN (Virtual Private Network) to the another terminal 400 to receive and process data transmitted from the another terminal 400 in accordance with an environment migration process and to transmit process results to the another terminal 400 through this VPN. The blade server 300 is a server apparatus normally used without local connection with input/output apparatuses.

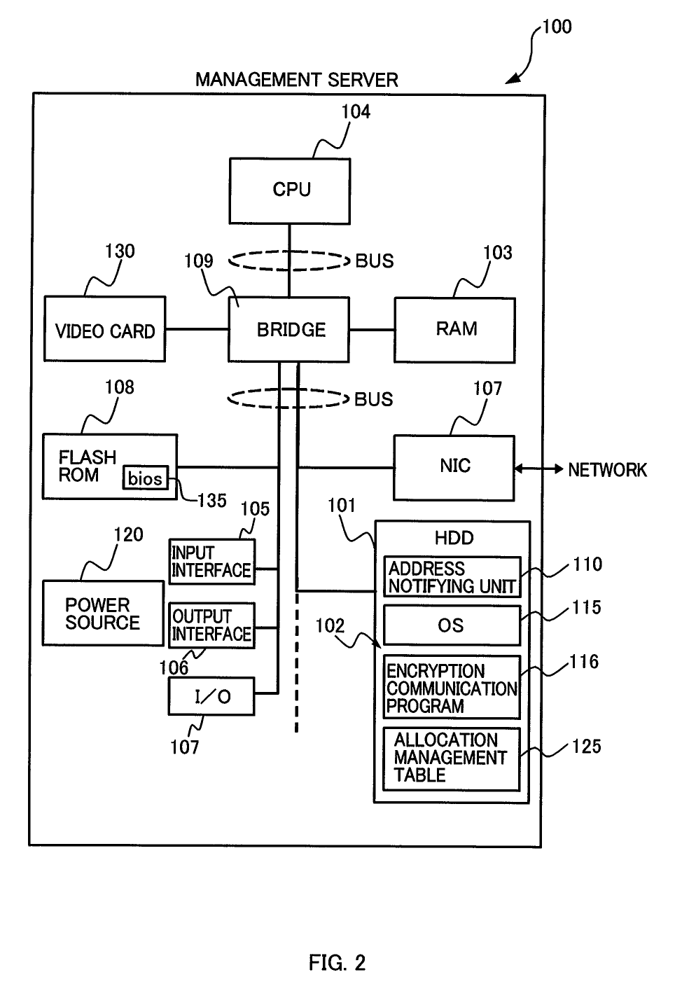

Each of apparatuses configuring the environment migration system 10 of the embodiment will be described. FIG. 2 depicts an exemplary configuration of the management server 100 of the embodiment. The management server 100 reads out onto a RAM 103 a program 102 included in a program database stored in a hard disk drive 101 so as to include functions realizing the present invention and executes the program with a CPU 104.

The management server 100 includes an input interface 105 such as various keyboards and buttons and an output interface 106 such as a display, which are typically included in a computer apparatus, as well as NIC (Network Interface Card) 107 responsible for giving/receiving data to/from the another terminal 400, the blade server 300, etc.

The management server 100 is coupled by the NIC 107 to the another terminal 400, the blade server 300, etc., through the network 140, for example, the Internet, LAN, and serial interface communication lines to give and receive data. The management server 100 includes a flash ROM 108, a video card 130 for coupling a display, a bridge 109 that relays a bus coupling the units 101 to 130, and a power source 120.

The flash ROM 108 has BIOS 135 stored thereon. After the power source 120 is turned on, the CPU 104 first accesses the flash ROM 108 and executes the BIOS 135 to recognize the system configuration of the management server 100. The hard disk drive 101 has OS 115 stored thereon along with functional units and tables. The OS 115 is a program for the CPU 104 generally controlling the units 101 to 110 of the management server 100 to execute functional units described later. In accordance with the BIOS 135, the CPU 104 loads the OS 115 from the hard disk drive 101 to the RAM 103 for execution. In this way, the CPU 104 generally controls the units of the management server 100.

Description will then be made of functional units configured and retained by the management server 100 based on the program 102, for example. It is assumed that the management server 100 includes in a suitable storage apparatus such as a hard disk an allocation management table 125 that stores a correlation between storage information of a portable storage medium 50 used by each user of the terminal 200, i.e., the thin client, and the address of the blade server 300 that is a destination of utilization allocation of the thin client 200 linked to the portable storage medium 50.

The management server 100 includes an address notifying unit 110 receiving from the another terminal a utilization allocation request including the storage information of the portable storage medium, checking the storage information of the portable storage medium included in the utilization allocation request against the allocation management table to identify the address of the information processing apparatus, and supplying the address to the another terminal that is the source of the utilization allocation request. An encryption communication program 116 is also included which is utilized in the case of communication processes with the another terminal 400, the thin client 200, and the portable storage medium 50.

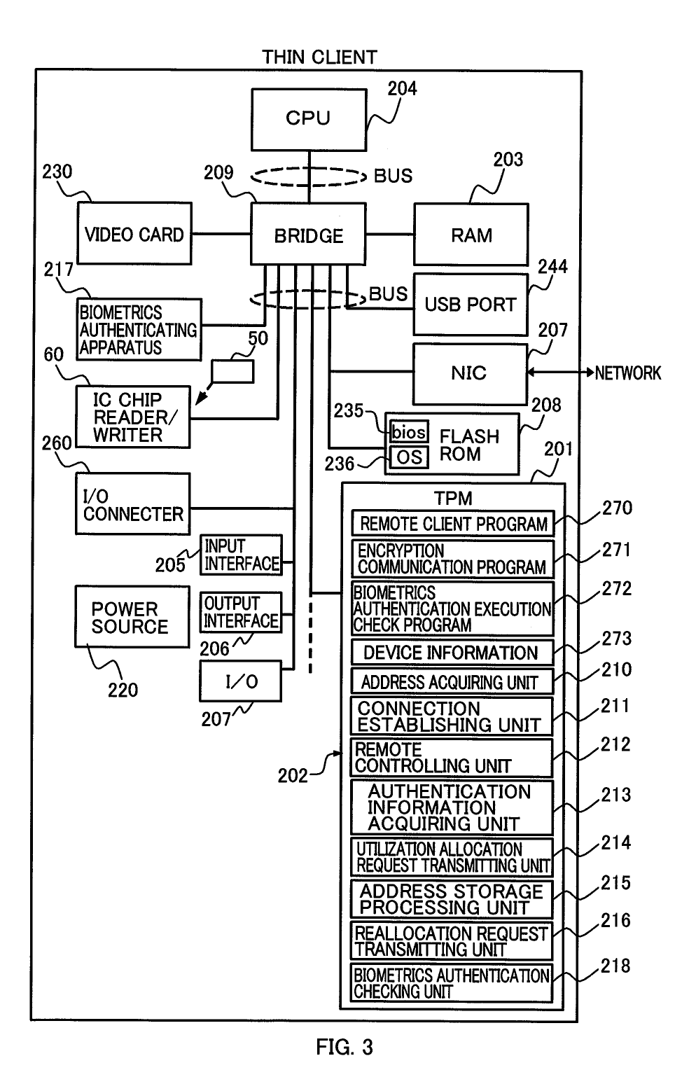

FIG. 3 depicts an exemplary configuration of the thin client 200 that is a terminal of the embodiment. On the other hand, the thin client 200 is an apparatus utilizing the blade server 300 through the network 140 in the situation where the utilization environment of the another terminal 400 is set in the blade server 300, reads out onto RAM 203 a program 202 stored in a program database of TPM 201, etc., and executes the program 202 with CPU 204 that is a calculating apparatus to implement functions necessary for utilizing the blade server 300.

The thin client 200 includes an input interface 205 such as various keyboards and buttons and an output interface 206 such as a display, which are typically included in a computer apparatus, as well as NIC 207 responsible for giving/receiving data to/from the management server 100, the blade server 300, etc.

The thin client 200 is coupled by the NIC 207 to the management server 100, the blade server 300, etc., through the network 140, for example, the Internet, LAN, and serial interface communication lines to give and receive data.

The thin client 200 is a so-called HDD-less PC and is configured such that a printer, an external drive, an external memory, etc., cannot be coupled locally or through a network. That is, the thin client 200 can use only a printer, an external drive, an external memory, etc., which are coupled locally or through a network to the blade server 300. In this way, information leaks are less likely to occur due to stealing of the thin client 200, etc.

The thin client 200 includes a USB port 244 for coupling various devices, flash ROM 208, an I/O connector 260 for coupling a keyboard and mouse, a video card 230 for coupling a display, a bridge 209 that relays a bus coupling the units 201 to 260, and a power source 220. After the power source 220 is turned on, the CPU 204 first accesses the flash ROM 208 and executes BIOS 235 to recognize the system configuration of the thin client 200.

An OS 236 in the flash ROM 208 is a program for the CPU 204 generally controlling the units 201 to 260 of the thin client 200 to execute programs corresponding to functional units described later. In accordance with the BIOS 235, the CPU 204 loads the OS 236 from the flash ROM 208 to the RAM 203 for execution. For the OS 236 of the embodiment, relatively small-sized OS is employed which can be stored in the flash ROM 208, such as embedded OS.

Description will then be made of functional units configured and retained in the TPM 201 by the thin client 200 that is the terminal based on the program 202, for example. The thin client 200 includes an address acquiring unit 210 reading the storage information of the portable storage medium 50 used by a user of the terminal 200, acquiring the address of the blade server 300 that is the destination of utilization allocation of the thin client 200 included in the storage information, and storing data of the address into the RAM 103.

The thin client 200 includes a connection establishing unit 211 transmitting a connection establishment request including at least authentication information of the thin client 200 or the user to the address of the blade server 300 stored in the RAM 103 and executing a connection establishment process through the network 140 between the blade server 300 and the thin client 200 in accordance with response data returned from the blade server 300 in response to the connection establishment request.

The thin client 200 includes a remote controlling unit 212 transmitting operation information input through the input interface 205 of the thin client 200 to the address of the blade server 300 in conjunction with the execution of the connection establishment process and receiving video information corresponding to the operation information from the blade server 300 to display the video information on the output interface 206 of the thin client 200.

The thin client 200 may preferably include an authentication information acquiring unit 213 that acquires the storage information of the portable storage medium 50 including the address of the management server 100 from a reader 60 of the portable storage medium 50 to store the information into the RAM 203 that is an appropriate memory.

The thin client 200 may preferably include a utilization allocation request transmitting unit 214 that includes and transmits the storage information of the portable storage medium 50 read from the RAM 103 that is the memory in a utilization allocation request for the blade server 300 to the address of the management server 100 stored in the RAM 203.

The thin client 200 may preferably include an address storage processing unit 215 receiving from the management server 100 the address of the blade server 300 that should be allocated to the own thin client 200 and storing the address of the blade server 300 into the portable storage medium 50.

The thin client 200 may preferably include a reallocation request transmitting unit 216 that transmits a reallocation request for the blade server 300 input through the input interface 205 of the thin client 200 to the address of the management server 100 along with the storage information of the portable storage medium 50.

The address storage processing unit 215 executes a process of receiving from the management server 100 the address of the available blade server 300 reallocated to the own thin client 200 and storing the address of the blade server 300 into the portable storage medium 50.

The reallocation request transmitting unit 216 may preferably execute the transmission process of the reallocation request when it is detected that at least one process cannot be executed among the connection establishment process with the blade server 300 by the connection establishing unit 211 and the process of transmitting the operation information to the blade server 300 or receiving video information from the blade server 300 by the remote controlling unit 212.

The thin client 200 may include a biometrics authenticating apparatus 217 that acquires biological information of a thin client user. In this case, a biometrics authentication checking unit 218 included in the thin client 200 checks the biological information acquired by the biometrics authenticating apparatus 217 against the biometrics authentication information acquired from the coupled portable storage medium 50 (preliminarily stored in the portable storage medium 50 as a reference for the check) to execute a biometrics authentication process. If the authentication result is “unauthenticated”, the utilization of the thin client 200 is disabled or the utilization allocation process of the blade server 300 to the thin client 200 is terminated.

In the thin client 200 of the embodiment, the chip called TPM (Trusted Platform Module) 201 houses the address acquiring unit 210, the connection establishing unit 211, the remote controlling unit 212, the authentication information acquiring unit 213, the utilization allocation request transmitting unit 214, the address storage processing unit 215, the reallocation request transmitting unit 216, the biometrics authenticating apparatus 217, the biometrics authentication checking unit 218, a remote client program 270, an encryption communication program 271, a biometrics authentication execution check program 272, device information 273, etc.

The TPM 201 has a function similar to a security chip mounted on a smart card (IC card) and is a hardware chip that has a calculation function using asymmetric keys and tamper proofness for securely storing the keys. The function of the TPM 201 includes generation/storage of RSA (Rivest-Shamir-Adleman Scheme) secret keys, calculation using RSA secret keys (signature, encryption, decryption), hash calculation of SHA-1 (Secure Hash Algorithm 1), retention of platform state information (software measurement values) (PCR), retention of a trust chain of keys, certificates, and credentials, generation of high-quality random numbers, non-volatile memory, and other Opt-ins and I/Os, for example.

The TPM includes a function for secure storage and notification of the platform state information (software measurement values) in a register PCR (Platform Configuration Registers) in the TPM 201 in addition to the generation/storage/calculation function for encryption keys (asymmetric keys). In the latest specification of the TPM 201, functions are added for locality, delegation (delegation of authority), etc. The TPM 201 must physically be mounted on a part of a platform (such as a motherboard).

The thin client 200 of the embodiment includes the remote client program 270 and the encryption communication program 271 in the TPM 201. The remote client program 270 is a program for the thin client 200 remotely accessing the desktop of the blade server 300 and is a client (viewer) program of the VNC, for example. The CPU 204 loads the remote client program 270 from the TPM 201 to the RAM 203 for execution in accordance with the OS 236. As a result, the CPU 204 transmits the input information of the I/O connector 260 (operation contents of the keyboard and mouse) to the blade server 300 through the network 140, for example, the VPN, and outputs the video information (desktop screen of the display) sent from the blade server 300 through the network 140, for example, the VPN, to the input/output interface 205 such as a display coupled to the video card 230.

The encryption communication program 271 is a communication program for establishing a secure communication network such as VPN to the blade server 300 having the address supplied from the remote client program 270. For example, it can be assumed that the program is a communication program using IPsec (Security Architecture for the Internet Protocol). The CPU 204 loads the encryption communication program 271 from the flash ROM 208 to the RAM 203 for execution in accordance with the OS 236. As a result, the CPU 204 transmits a communication start request through the NIC 207 to the blade server 300 allocated to the own thin client 200 to establish a network such as VPN to the blade server 300 and communicates with the blade server 300 through the VPN, etc.

The thin client 200 of the embodiment includes the biometrics authentication execution check program 272 in the TPM 201. The biometrics authentication execution check program 272 recognizes the own hardware configuration at the time of start-up of the thin client 200, and instructs the biometrics authentication checking unit 218 to start the execution of the biometrics authentication process if the biometrics authenticating apparatus 217 is included in the hardware configuration.

The thin client 200 of the embodiment includes the device information 273 in the TPM 201. The device information 273 is authentication information of the thin client 200 included in a connection establishment request, etc., when the thin client 200 transmits the connection establishment request, etc. Specifically, it can be assumed that the information is the ID, model number, and MAC address of the thin client 200, for example.

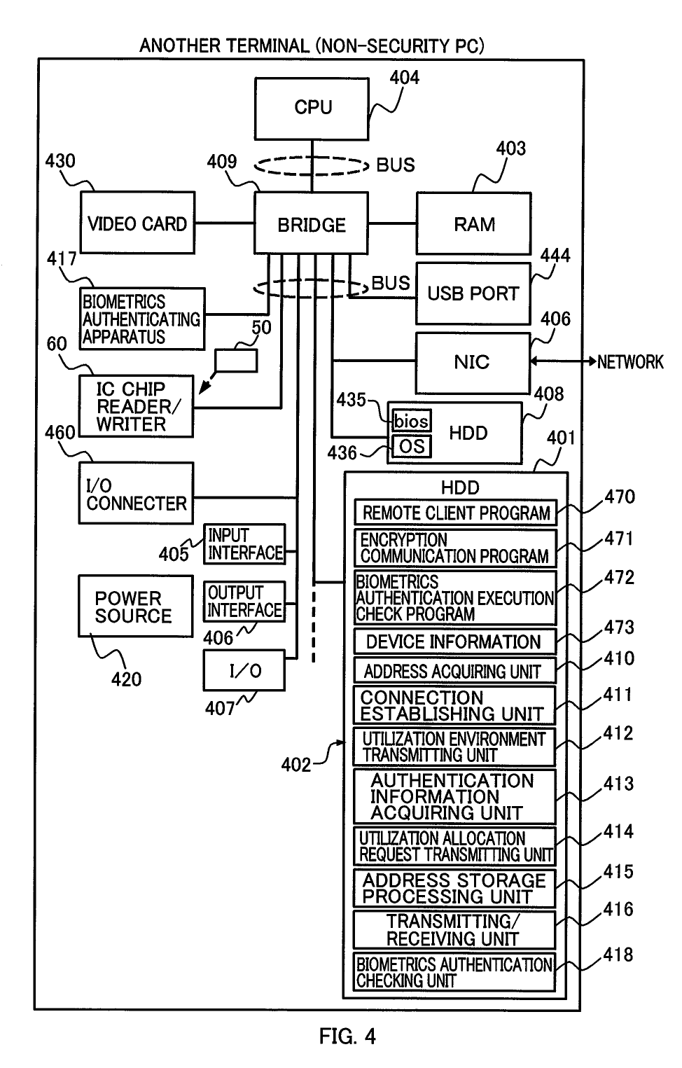

FIG. 4 depicts an exemplary configuration of the another terminal 400 of the embodiment. On the other hand, the another terminal 400 is a terminal apparatus that has a utilization environment used as the utilization environment of the thin client 200, reads out onto RAM 403 a program 402 stored in a program database of a hard disk 401, etc., and executes the program 402 with CPU 404 that is a calculating apparatus to implement functions realizing the present invention.

The another terminal 400 includes an input interface 405 such as various keyboards and buttons and an output interface 406 such as a display, which are typically included in a computer apparatus, as well as NIC 407 responsible for giving/receiving data to/from the management server 100, the blade server 300, etc.

The another terminal 400 is coupled by the NIC 407 to the management server 100, the blade server 300, etc., through the network 140, for example, the Internet, LAN, and serial interface communication lines to give and receive data.

The another terminal 400 is different from the thin client 200 and can be assumed to be a normal PC including HDD (although a thin-client-type PC may also be used).

The another terminal 400 includes a USB port 444 for coupling various devices, a hard disk drive 408, an I/O connector 460 for coupling a keyboard and mouse, a video card 430 for coupling a display, a bridge 409 that relays a bus coupling the units 401 to 460, and a power source 420. After the power source 420 is turned on, the CPU 404 first accesses the hard disk drive 408 and executes BIOS 435 to recognize the system configuration of the another terminal 400.

An OS 436 in the hard disk drive 408 is a program for the CPU 404 generally controlling the units 401 to 460 of the another terminal 400 to execute programs corresponding to functional units described later. In accordance with the BIOS 435, the CPU 404 loads the OS 436 from the hard disk drive 408 to the RAM 403 for execution.

Description will then be made of functional units configured and retained in the hard disk drive 408 by the another terminal 400 based on the program 402, for example. The another terminal 400 includes an address acquiring unit 410 reading the storage information of the portable storage medium 50 used by a person who will be a user of the terminal 200, acquiring the address of the blade server 300 that is the destination of utilization allocation of the thin client 200 included in the storage information, and storing the address into the RAM 403 that is a memory.

The another terminal 400 includes a connection establishing unit 411 transmitting a connection establishment request including at least authentication information of the thin client 200 or the user to the address of the blade server 300 stored in the RAM 403 and executing a connection establishment process through the network 140 between the blade server 300 and the another terminal 400 in accordance with response data returned from the blade server 300 in response to the connection establishment request.

The another terminal 400 includes a utilization environment transmitting unit 412 extracting utilization environment data of the another terminal 400 in conjunction with the execution of the connection establishment process and transmitting the utilization environment data to the address of the blade server 300. When extracting the utilization environment data of the another terminal 400, for example, the another terminal 400 reads a table (preliminarily ensured in the hard disk drive 401, etc.) preliminarily defining data attributes to be extracted and the extraction can be performed by reading data conforming to the attributes defined in this table.

The another terminal 400 includes an authentication information acquiring unit 413 that acquires the storage information of the portable storage medium 50 including the address of the management server 100 from the reader 60 (e.g., USB interface) of the portable storage medium 50 to store the information into the appropriate RAM 403.

The another terminal 400 may include a utilization allocation request transmitting unit 414 that includes and transmits the storage information of the portable storage medium 50 read from the RAM 403 in a utilization allocation request for the blade server 300 to the address of the management server 100 stored in the RAM 403.

The another terminal 400 may include an address storage processing unit 415 receiving from the management server 100 the address of the blade server 300 that should be allocated to the thin client 200 and storing the address of the blade server 300 into the portable storage medium 50.

It can be assumed that the portable storage medium 50 includes the functional units included in the another terminal 400 (details of the functions will be described later). In such a case, the another terminal 400 may include a transmitting/receiving unit 416 transmitting output data of the utilization allocation request transmitting unit 414 of the portable storage medium 50 through the network 140 to the management server 100 and sending back the address of the blade server 300 sent from the management server 100 to the address storage processing unit 415 of the portable storage medium 50.

The another terminal 400 may include a biometrics authenticating apparatus 417 that acquires biological information of a terminal user. In this case, a biometrics authentication checking unit 418 included in the another terminal 400 checks the biological information acquired by the biometrics authenticating apparatus 417 against the biometrics authentication information acquired from the coupled portable storage medium 50 (preliminarily stored in the portable storage medium 50 as a reference for the check) to execute a biometrics authentication process. If the authentication result is “unauthenticated”, the utilization of the another terminal 400 is disabled or the utilization allocation process of the blade server 300 to the another terminal 400 is terminated.

In this embodiment, the another terminal 400 may include an encryption communication program 471 in the hard disk drive 201. The encryption communication program 471 is a communication program for establishing a secure communication network such as VPN to the blade server 300 having the address supplied from a remote client program 470 (similar to the program included in the thin client 200 and stored in the hard disk drive 201). For example, it can be assumed that the program is a communication program using IPsec. The CPU 404 loads the encryption communication program 471 from the hard disk drive 408 to the RAM 403 for execution in accordance with the OS 436. As a result, the CPU 404 transmits a communication start request through the NIC 407 to the blade server 300 allocated to the another terminal 400 to establish a network such as VPN to the blade server 300 and communicates with the blade server 300 through the VPN, etc.

In this embodiment, the another terminal 400 may include a biometrics authentication execution check program 472 in the hard disk drive 201. The biometrics authentication execution check program 472 recognizes the own hardware configuration at the time of start-up of the another terminal 400, and instructs the biometrics authentication checking unit 418 to start the execution of the biometrics authentication process if the biometrics authenticating apparatus 417 is included in the hardware configuration.

In this embodiment, the another terminal 400 may include device information 473 in the hard disk drive 401. The device information 473 is authentication information of the thin client 200 or the another terminal 400 included in a connection establishment request, etc., when the another terminal 400 transmits the connection establishment request, etc. Specifically, it can be assumed that the information is the ID, model number, and MAC address of the thin client 200 or the another terminal 400, for example.

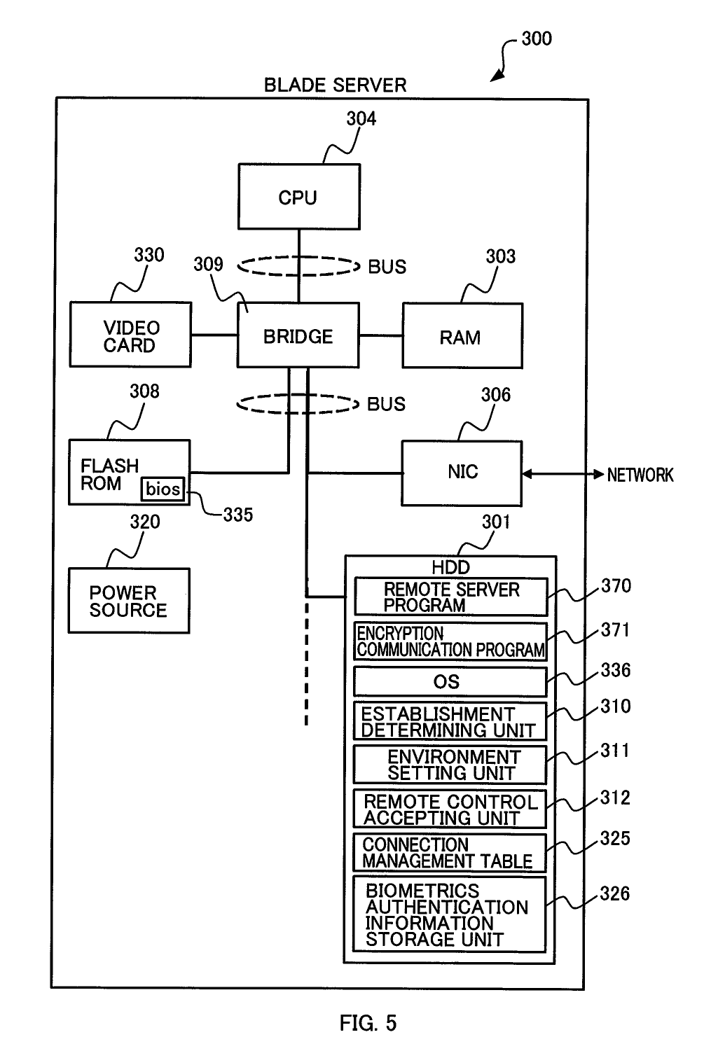

FIG. 5 depicts an exemplary configuration of the blade server 300 that is an information processing apparatus of the embodiment. On the other hand, the blade server 300 is an information processing apparatus and is an apparatus accepting the setting of the utilization environment in the another terminal 400 as a utilization environment at the time of using the thin client 200 and then allowing utilization through a network from the thin client 200. The blade server 300 reads out onto RAM 303 a program 302 included in a program database stored in HDD 301, etc., and executes the program 402 with CPU 304 that is a calculating apparatus to implement functions realizing the present invention.

The blade server 300 includes an input interface 305 such as various keyboards and buttons and an output interface 306 such as a display, which are typically included in a computer apparatus, as well as NIC 307 responsible for giving/receiving data to/from the management server 100, the another terminal 400, the thin client 200, etc.

The blade server 300 is coupled by the NIC 307 to the management server 100, the thin client 200, the another terminal 400 etc., through the network 140, for example, the Internet, LAN, and serial interface communication lines to give and receive data. The blade server 300 also includes a flash ROM (Read Only Memory) 308, a video card 330 that generates desktop video information, a bridge 309 that relays the units 301 to 330 and a bus, and a power source 320.

The flash ROM 308 has BIOS (Basic Input/Output System) 335 stored thereon. After the power source 320 is turned on, the CPU 304 first accesses the flash ROM 308 and executes the BIOS 335 to recognize the system configuration of the blade server 300.

Description will then be made of functional units configured and retained by the blade server 300 based on the program 302, for example. The blade server 300 includes a connection management table 325 that stores authentication information of the thin client 200 or a user allocated to the blade server 300 for utilization. The blade server 300 may preliminarily acquire biometrics authentication information of the user stored in an appropriate certification body (such as public individual certification body) or the portable storage medium 50 from a server of the certification body or the thin client and may store the information into a biometrics authentication information storage unit 326.

The blade server 300 includes an establishment determining unit 310 receiving the connection establishment request transmitted from the another terminal 400, checking the authentication information of the thin client 200 or user included in the connection establishment request against the connection management table 325 to determine whether the connection establishment request can be accepted, and sending back the determination result as response data to the another terminal 400. It is more preferable that the establishment determining unit 310 includes a biometrics authentication process of checking biological information associated with the connection establishment request (so-called raw biological information read by the biometrics authenticating apparatus 417 of the another terminal) against the biometrics authentication information of the biometrics authentication information storage unit 326. That is, it is determined that the connection establishment process is not executed unless passing the biometrics authentication.

The blade server 300 includes an environment setting unit 311 that receives utilization environment data from the another terminal 400 to store the utilization environment data into a storage apparatus as the utilization environment data of the thin client 200 as the connection establishment process is executed for the another terminal 400 in accordance with the determination result.

The blade server 300 may include a remote control accepting unit 312 receiving operation information from the thin client 200 as the connection establishment process is subsequently executed for the thin client 200, executing an information process in accordance with the operation contents indicated by the operation information, and transmitting video information showing the result to the thin client 200.

The blade server 300 has a remote server program 370, an encryption communication program 371, and an OS (Operating System) 336 in the HDD 301. The OS 336 is a program for the CPU 304 generally controlling the units 301 to 330 of the blade server 300 to execute programs realizing functional units such as the functional unit 310. In accordance with the BIOS 335, the CPU 304 loads the OS 336 from the HDD 301 to the RAM 303 for execution. In this way, the CPU 304 generally controls the units 301 to 330 of the blade server 300.

The remote server program 370 is a program for enabling the remote control of the desktop of the blade server 300 from the thin client 200 and is a server program for VNC (Virtual Network Computing) developed by AT&T Laboratories Cambridge, for example. In accordance with the OS 336, the CPU 304 loads the remote server program 370 from the HDD 301 to the RAM 303 for execution. As a result, the CPU 304 receives and processes the input information (operation contents of the keyboard and mouse) sent from the thin client 200 through the network 140 such as VPN and transmits the video information (desktop screen of the display) showing the process result to the thin client 200 through the network 140 such as VPN.

The encryption communication program 371 is a communication program for establishing the network 140 such as VPN to the another terminal 400 and the thin client 200 and is a communication program using IPsec (Security Architecture for the Internet Protocol), for example. In accordance with the OS 336, the CPU 304 loads the encryption communication program 371 from the HDD 301 to the RAM 303 for execution. As a result, CPU 304 establishes the secure communication network 140 such as VPN to the another terminal 400 and the thin client 200 in accordance with the communication establishment request accepted from the another terminal 400 and the thin client 200 through the NIC 307 and communicates with the another terminal 400 and the thin client 200 through the VPN, etc.

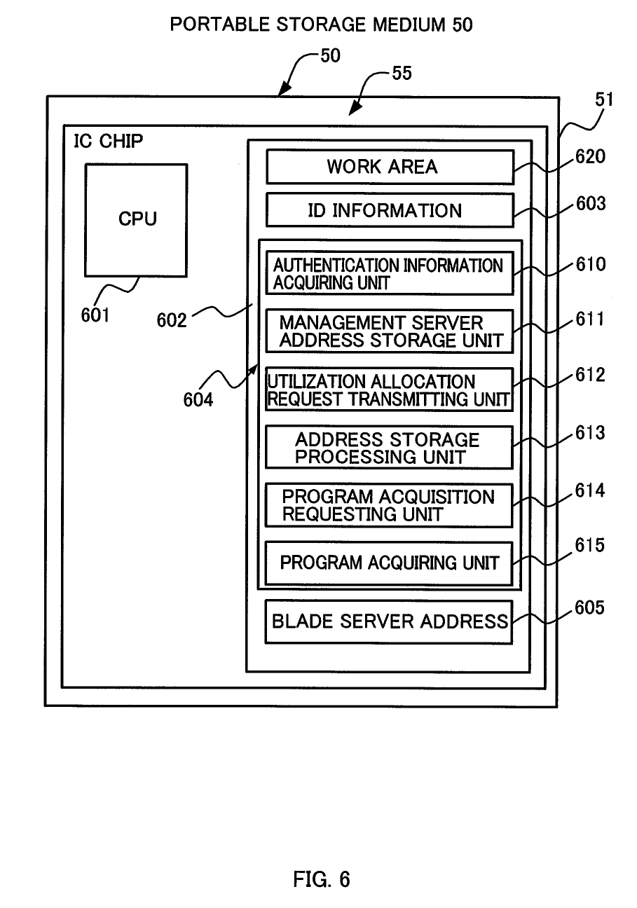

FIG. 6 depicts an exemplary configuration of an IC chip 55 included in the portable storage medium 50 of the embodiment. An example of the portable storage medium 50 is a USB device, etc., having the IC chip 55 stored in a suitable storage case such as a plastic housing to be coupled to the USB interface of the another terminal 400 and the thin client 200 in a manner enabling data communication. The storage information of the IC chip 55 includes a chip ID 603. The IC chip 55 is configured by a CPU 601 and a memory 602, and the memory 602 stores information 603 of the chip ID. The memory 602 may have stored thereon a program 604 including a function realizing the present invention. In this case, the portable storage medium 50 executes the program 604 stored in the memory 602 with the CPU 601.

For the portable storage medium 50, an authentication device (KeyMobile™) can be employed which has a personal certificate, a secret key, and various pieces of application software necessary for mobile usage preinstalled in a memory card integrating an IC card unit and a flash memory. The information stored in the memory 602 of the portable storage medium 50 is assumed to be the information 603 of the chip ID and an address of the management server 100 that executes the utilization allocation process between the another terminal (or the thin client 200) and the blade server 300 (a management server address storage unit 611) as well as an address 605 of the blade server 300 that is the destination of utilization allocation of the another terminal 400 (or the thin client 200).

Description will be made of functional units configured and retained by the portable storage medium 50 based on the program 604, for example. The portable storage medium 50 may include an authentication information acquiring unit 610 that acquires and stores the storage information of the portable storage medium 50 into an appropriate memory of the portable storage medium itself or the another terminal 400.

The portable storage medium 50 may include the management server address storage unit 611 having stored thereon the address of the management server 100 that executes the utilization allocation process between the thin client 200 and the blade server 300.

The portable storage medium 50 may include a utilization allocation request transmitting unit 612 that includes and transmits the storage information of the portable storage medium 50 read from the memory 602 in a utilization allocation request for the blade server 300 to the address of the management server 100 stored in the management server address storage unit 611 through the another terminal 400.

The portable storage medium 50 may include an address storage processing unit 613 receiving the address of the blade server 300 that should be allocated to the thin client 200 transmitted from the management server 100 through the another terminal 400 and storing the address of the blade server 300 into the own appropriate memory 602 of the portable storage medium 50.

If the management server 100 has programs including the functions of the authentication information acquiring unit, the utilization allocation request transmitting unit, and the address storage processing unit 613 stored in the storage apparatus of the management server 100, the portable storage medium 50 includes the following functional units. In this case, the portable storage medium 50 may include the management server address storage unit 611, a program acquisition requesting unit 614 that extracts the address of the management server 100 from the management server address storage unit 611 to transmit an acquisition request for the program to this address, and a program acquiring unit 615 that downloads the program from the management server 100 in accordance with the acquisition request for the program to store the program into a memory of the portable storage medium itself or the another terminal 400.

The functional units 110, 210 to 218, 310 to 311, 410 to 418, 610 to 615, etc., of the management server 100, the another terminal 400, the blade server 300, the thin client 200, the portable storage medium 50 configuring the environment migration system shown above may be implemented by hardware or may be implemented by programs stored in appropriate storage apparatuses such as memory and HDD (Had Disk Drive). In this case, in conformity to the execution of the programs, the CPUs 104, 204, 304, 404, and 601 read corresponding programs from the storage apparatuses onto the RAMs 103, 203, 403, and 602 and execute the programs.

The network 140 can be employed as various networks such as ATM lines, dedicated lines, WAN (Wide Area Network), power line network, wireless network, public line network, portable phone network, and serial interface communication line, in addition to the Internet and LAN. If virtual private network technologies such as VPN (Virtual Private Network) are used, communications with higher security are preferably established when employing the Internet. The serial interface indicates an interface for coupling to an external device through serial transmission that uses a single signal line to sequentially send data bit-by-bit, and a communication mode can be assumed to be RS-232C, RS-422, IrDA, USB, IEEE1394, Fiber Channel, etc.

—Database Configuration—

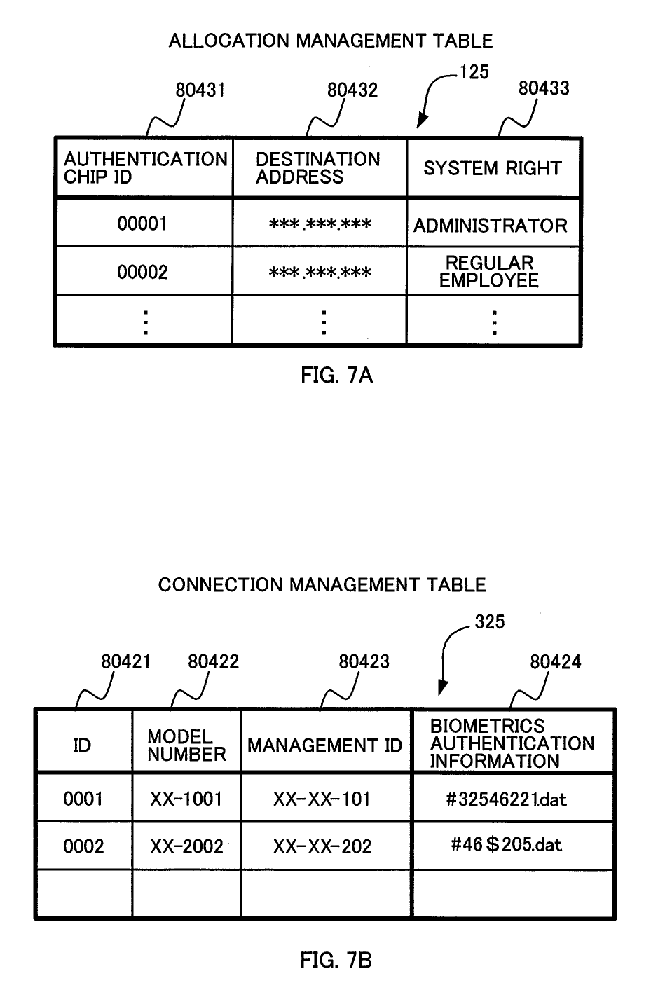

Configurations of various tables available to the management server 100, the blade server 300, and the another terminal 400 configuring the information processing system 10 in the embodiment will be described. FIGS. 7A and 7B depict exemplary data configurations of the allocation management table 125 and the connection management table 325 in the embodiment, respectively.

The allocation management table 125 is used by the management server 100 and is a table that stores a correlation between the storage information of the portable storage medium 50 used by each user of the thin client 200, and the address of the blade server 300 that is a destination of utilization allocation of the thin client 200 linked to the portable storage medium 50. For example, the allocation management table 125 is an aggregate of records correlating pieces of information such as an address 80432 of the blade server 300 and a system right 80433 (a range of utilization right of the blade server corresponding to a duty position and the like), using a chip ID 80431 of the IC chip 55 included in the portable storage medium 50 as a key. The address 80432 of the blade server 300 can be assumed to be an IP address of the blade server 300 in the network 140.

The connection management table 325 is used by the blade server 300 and is a table that stores authentication information of the thin client 200 or a user allocated to the blade server 300 for utilization. For example, the connection management table 325 is a table that stores authentication information (device information such as MAC address) of each of the thin clients 200 and is an aggregate of records correlating pieces of information such as a model number 80422 of the thin client 200 and a management ID 80423 set to the thin client 200, using an ID 80421 of the thin client 200 as a key, for example. The authentication information stored in the connection management table 325 can also be assumed to be biometrics authentication information 80424 (such as fingerprint, iris, vein, face image, and voiceprint) of a user of the thin client 200, a user ID, and a password. The authentication information stored in the connection management table 325 can be assumed to be the same as the storage information stored in the portable storage medium 50 except the address of the thin client 200. That is, the storage information of the portable storage medium 50 is the address of the blade server 300 that is the destination of utilization allocation of the thin client 200 and the authentication information of the thin client 200 or the user.

—First Process Flow Example—

Actual procedures of the environment migrating method of the embodiment will hereinafter be described with reference to the figures. Various operations corresponding to the environment migrating method described below is implemented by a program read onto each RAM of the management server 100, the another terminal 400, and the blade server 300 configuring the environment migration system 10 for execution. The program is configured by codes for performing various operations described below.

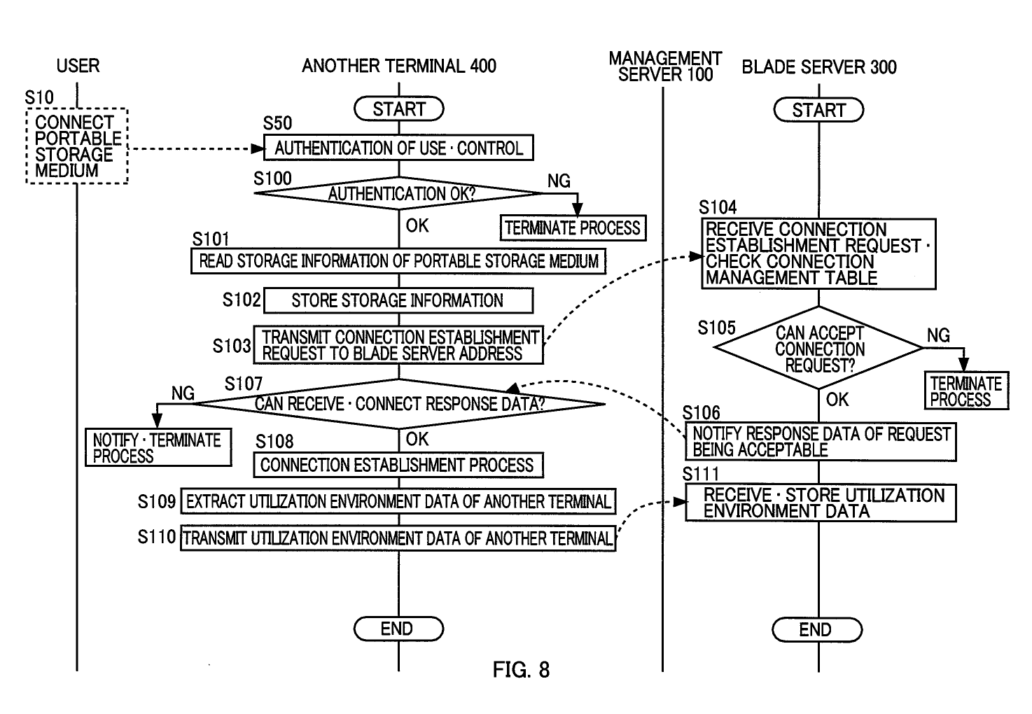

FIG. 8 depicts a first process flow example of an environment migrating method in the embodiment. It is assumed that a user having the portable storage medium 50 in the form of a USB device decides to use the blade server 300 through the thin client 200. In this case, the user must migrate a utilization environment of a PC that has been used by the user other than the thin client 200, for example, a non-security PC (including a hard disk drive), which is a very common PC, to a thin client system consisting of the thin client 200 and the blade server 300.

Therefore, the user couples the portable storage medium 50 to the USB interface (reader 60) of the another terminal 400 (s10). For the portable storage medium 50, an authentication device (KeyMobile™) can be employed which has a personal certificate, a secret key, and various pieces of application software necessary for mobile usage preinstalled in a memory card integrating an IC card unit and a flash memory.

Such an authentication device is more than a mere storage apparatus and can store an authentication application to execute an authentication process in cooperation with the another terminal 400 to which the device is coupled. Therefore, when the portable storage medium 50 is coupled to the USB interface of the another terminal 400, for example, an authentication application is activated from a storage area of the portable storage medium 50 to perform control such that a program included in the another terminal 400 or the portable storage medium 50 necessary for an environment migration process cannot be activated unless appropriate authentication information (such as user ID, password, and biological information) is input through the input interface 405 (s50).

If the authentication result of the authentication application of the portable storage medium 50 is “authentication OK” (s100: OK), the address acquiring unit 410 of the another terminal 400 reads the storage information of the portable storage medium 50 used by a person who will be a user of the thin client 200 (s101), acquires an address of the blade server that is the destination of utilization allocation of the thin client 200 included in the storage information, and stores the address into the RAM 403 (s102).

The connection establishing unit 411 of the another terminal 400 then transmits a connection establishment request including at least authentication information of the thin client 200 or the user (e.g., the device information 273 of the thin client 200 or the authentication information of the user stored in the portable storage medium 50) to the address of the blade server 300 stored in the RAM 403 (s103). The connection establishing unit 411 may acquire the biological information of the user from the biometrics authenticating apparatus 417 and include the biological information in the authentication information of the connection establishment request. At the time of this process, the encryption communication program 471 is started in the another terminal 400. The connection establishing unit 411 notifies the encryption communication program 471 of the address of the blade server 300. The encryption communication program 471 receives this address and ensures a network between the another terminal 400 and the blade server 300 to establish a secure network environment involving encryption of communication data.

On the other hand, the establishment determining unit 310 of the blade server 300 receives the connection establishment request and checks the authentication information of the thin client 200 or user included in the connection establishment request against the connection management table 325 (s104). If the connection management table 325 does not include setting of allocation for the thin client 200 or user in this checking process, it is determined that the connection establishment request cannot be accepted (s105: NO), and the determination result is sent back as response data to the another terminal 400 to terminate the process. On the other hand, if the connection management table 325 includes setting of allocation for the thin client 200 or user in this checking process, it is determined that the connection establishment request can be accepted (s105: OK), and the determination result is sent back as response data to the another terminal 400 (s106). When checking the authentication information against the connection management table 325, it is more preferable to execute a process of checking the biological information of the user included in the authentication information against the biometrics authentication information storage unit 326. If the result of the checking process for the biological information is included in the result determining whether the connection establishment request can be accepted, security is more improved when utilizing the blade server 300 from the another terminal 400.

On the other hand, the another terminal 400 transmitting the connection establishment request receives the response data returned from the blade server 300, and if the response data indicate that “connection can be established” (s107: OK), the another terminal 400 executes a connection establishment process between the blade server 300 and the another terminal 400 through the network 140 (s108). If the response data returned from the blade server 300 indicates that “connection cannot be established” (s107: NG), the subsequent process is terminated.

At the time of the connection establishment process, the remote client program 470 included in the another terminal 400 may transmit an authentication request to the address of the blade server 300. In response to this authentication request, the blade server 300 returns, for example, a login ID, password, or input request for biological information to the another terminal 400. When the another terminal 400 returns the login ID, password, etc., in response to this input request, the blade server 300 determines whether a login ID and password managed by the blade server 300 are identical to the login ID and password originating from the another terminal 400 to conclusively determine availability of the blade server 300.

After the step s108, a utilization environment transmitting unit 412 of the another terminal 400 extracts data of the utilization environment of the another terminal 400 in accordance with execution of the connection establishment process corresponding to the response data (s109). At the time of this extraction process, for example, the portable storage medium 50 or the another terminal 400 preliminarily includes a table for data attributes to be extracted, and data having the data attributes set in the table are searched/extracted in the storage apparatus such as the hard disk drive 401 of the another terminal 400. Specific examples of the utilization environment data to be extracted are “favorite” files of a web browser, mail account setting of e-mail software, address books, sorting rules of transmission/reception e-mails, files created by various application programs, desktop display setting, etc.

The utilization environment transmitting unit 412 transmits the extracted utilization environment data to the address of the blade server 300 (s110). The environment setting unit 311 of the blade server 300 receives the utilization environment data from the another terminal 400 to store the utilization environment data into the storage apparatus as the utilization environment data of the thin client 200 as the connection establishment process is executed for the another terminal 400 in accordance with the determination result (s111). In this process, for example, an application, etc., corresponding to the utilization environment data extracted from the another terminal 400 are identified in a storage area reserved for the thin client 200, and the utilization environment data are set in the application, etc. In a specific example, an address book and sorting rules of transmission/reception e-mails acquired from the another terminal 400 are set in a mailer included in the server 300 allowing the mailer to be provided to the thin client 200 in some cases. Alternatively, in a word processor application program similarly prepared by the blade server 300, a dictionary file included in the application program is replaced by and set to a dictionary file acquired from the another terminal 400 in other cases. When the thin client 200 subsequently accesses and utilizes the blade server 300, an environment is prepared which is the same as that utilized in the another terminal 400.

Therefore, in the environment migration system of the embodiment, the utilization environment of the another terminal 400 can efficiently be set to the blade server 300 using a key that is the portable storage medium 50 such as the authentication device. Moreover, since the highly tamper-proof authentication device (such as KeyMobile™) is used for the portable storage medium 50 coupled to the another terminal 400 at the time of use and the data and application for connection with the blade server 300 are stored in the authentication device, unauthorized use of the blade server 300 can well be constrained.

—Second Process Flow Example—

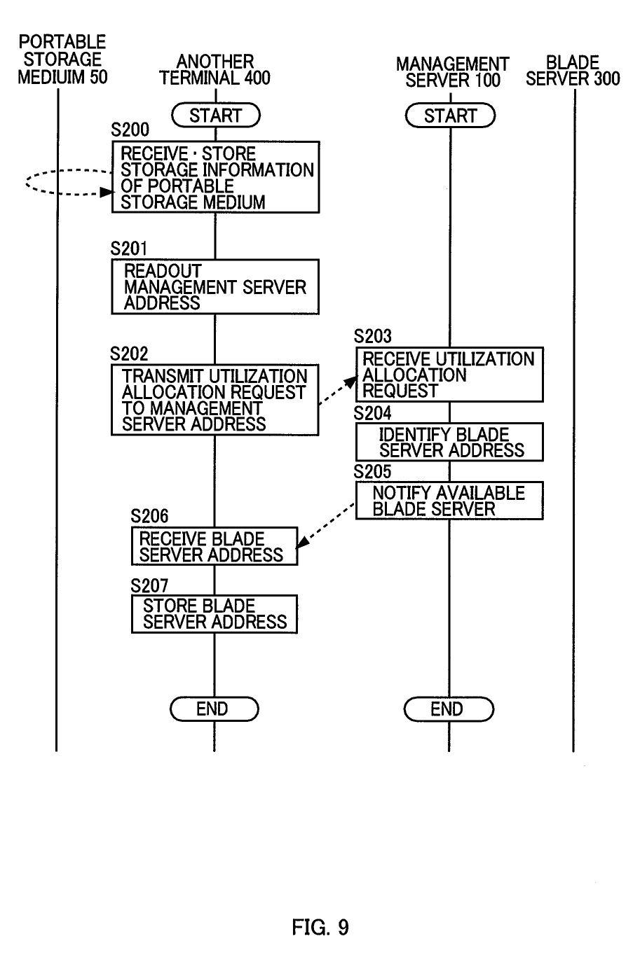

FIG. 9 depicts a second process flow example of the environment migrating method in the embodiment. Although the address of the blade server 300 is stored in the portable storage medium 50 in the above example, the address can be acquired as follows. That is, the authentication information acquiring unit 413 of the another terminal 400 acquires the storage information (including the address of the management server) of the portable storage medium 50 from the reader of the portable storage medium 50 to store the information into the appropriate RAM 403 (s200).

The utilization allocation request transmitting unit 414 reads the address of the management server 100 from the RAM 403 (s201). The storage information of the portable storage medium 50 read from the RAM 403 is included within the utilization allocation request for the blade server 300 and is transmitted to this address (s202).

On the other hand, the address notifying unit 110 of the management server 100 receives from the another terminal 400 the utilization allocation request including the storage information of the portable storage medium 50 (s203), checks the storage information of the portable storage medium 50 included in the utilization allocation request against the allocation management table 125 to identify the address of the blade server 300 (s204), and supplies the address to the another terminal 400 that is the source of the utilization allocation request (s205).

The address storage processing unit 415 of the another terminal 400 receives from the management server 100 the address of the blade server 300 that should be allocated to the thin client 200 (s206) and stores the address of the blade server 300 into the portable storage medium 50 (s207). In this way, the address of the blade server 300 is stored into the portable storage medium 50.

—Third Process Flow Example—

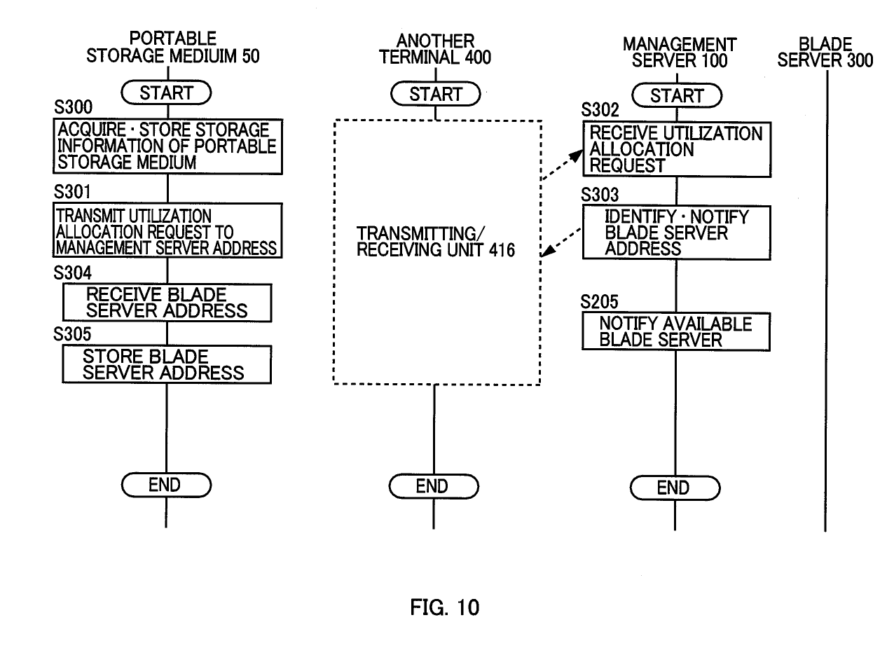

FIG. 10 depicts a third process flow example of the environment migrating method in the embodiment. In another example described here, the portable storage medium 50 includes the functional units that were included in the another terminal 400. In this case, if a user merely carries the portable storage medium 50, the user can connect the portable storage medium 50 to the user's own in-use computer and can connect the computer to the blade server 300 just like the thin client to perform an environment migration process more conveniently and efficiently. Moreover, if the above authentication device (KeyMobile™) is used as the portable storage medium 50, higher security can be ensured.

Under such a situation, the portable storage medium 50 initiates a process to realize the utilization environment of the another terminal 400 when utilizing the thin client 200. In this case, the authentication information acquiring unit 610 of the portable storage medium 50 acquires and stores the storage information of the portable storage medium 50 into an appropriate memory 620 of the portable storage medium 50 itself (or the another terminal 400) (s300). In the situation where the portable storage medium 50 in a form of a USB device, etc., is coupled to the another terminal 400, the storage information acquired by the authentication information acquiring unit 610 may be stored in the another terminal 400.

The utilization allocation request transmitting unit 612 of the portable storage medium 50 includes and transmits the storage information of the portable storage medium 50 read from the memory in a utilization allocation request for the blade server 300 to the address of the management server 100 stored in the management server address storage unit 611 through the another terminal 400 (s301). This transmission process is executed by the utilization allocation request transmitting unit 612 supplying the data of the utilization allocation request to the transmitting/receiving unit 416 of the another terminal 400 coupled with the portable storage medium 50. The transmitting/receiving unit 416 specifies the address of the management server 100 and instructs the communicating apparatus 407 to execute data communication for the utilization allocation request through the network 140.

The management server 100 receives the utilization allocation request through the another terminal 400 (s302) and identifies the address of the blade server 300 allocated to the thin client 200 to send back the address information to the another terminal 400 (s303).

The transmitting/receiving unit 416 of the another terminal 400 acquires from the communication apparatus 407 the address information returned from the management server 100 and transfers the address information to the address storage processing unit 613 of the portable storage medium 50.

The address storage processing unit 613 of the portable storage medium 50 receives the address of the blade server 300 that should be allocated to the thin client 200 returned from the management server 100 (s304) and stores the address of the blade server 300 into the own appropriate memory 602 of the portable storage medium 50 itself (s305).

The portable storage medium 50 acquires the address of the blade server 300 that is a counterpart to be coupled to the another terminal 400 and executes the same process as that executed by the another terminal 400 described in the first flow example to execute the environment migration process. To that end, of course, the portable storage medium 50 must include the same functional unit as that included in the another terminal 400 in a form of a program, for example.

—Fourth Process Flow Example—

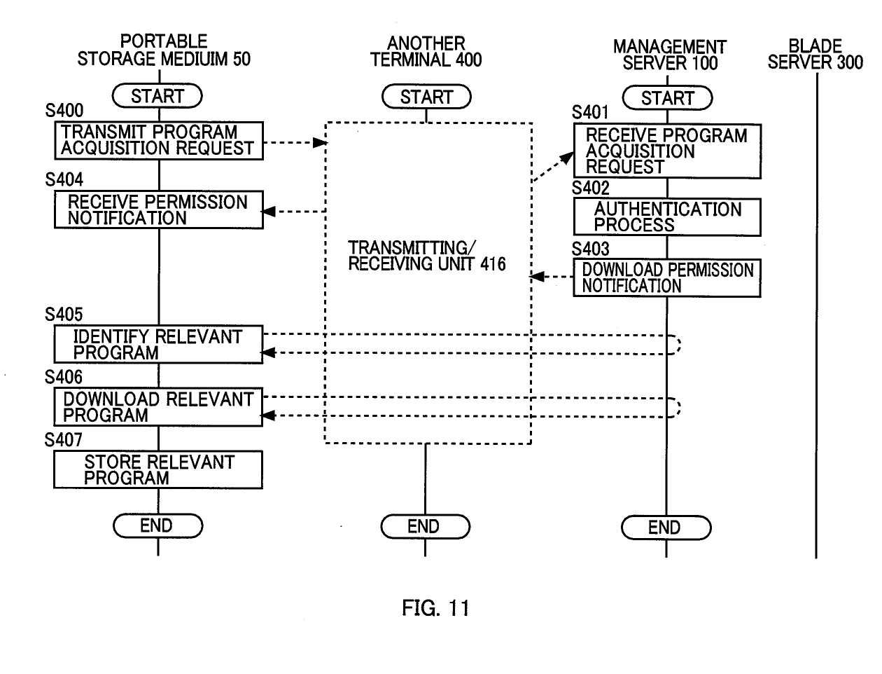

FIG. 11 depicts a fourth process flow example of the environment migrating method in the embodiment. In another example described here, the portable storage medium 50 acquires a program realizing function units necessary for the environment migration process from the management server 100. Therefore, in this case, it is assumed that the management server 100 stores in an appropriate storage apparatus such as the hard disk drive 101 the program realizing the function units of the program including the function that was assumed to be included in the another terminal 400.

In this case, the program acquisition requesting unit 614 of the portable storage medium 50 extracts the address of the management server 100 from the management server address storage unit 611 to transmit an acquisition request for the program to this address (s400).

The management server 100 receives the acquisition request for the program (s401), executes an appropriate authentication process with the portable storage medium 50 (s402), and notifies the portable storage medium 50 of the download permission for the program (s403). If the result of the authentication process is “authentication NG”, the process is of course terminated.

When receiving the download permission notification (s404), the program acquiring unit 615 of the portable storage medium 50 searches/identifies the program in the storage apparatus of the management server 100 (s405), and downloads the identified program (s406). The downloaded program is stored in the memory 602 of the portable storage medium 50 (or the another terminal 400) (s407). In this way, with the program, the portable storage medium 50 finally assures the function that was assumed to be included in the another terminal 400.

Although VPN is established for communications between the blade server 300 and the another terminal 400 in the described example in the above embodiment, this is not a limitation to the present invention. For example, in such a case that the blade server 300 and the another terminal 400 exist within the same LAN, the blade server 300 and the another terminal 400 may be allowed to communicate with each other without establishing VPN.

Although it is preferable that the portable storage medium 50 is assumed to be the authentication device, the portable storage medium 50 may also be assumed to be a portable telephone, etc., including the same functions and connectivity with the another terminal 400 and the thin client 200.

According to the present invention, when a utilization environment of a non-security PC is migrated as a utilization environment of a thin client, a migration process ensuring efficient and good security can be realized.

Although the present invention has specifically been described based on the embodiments thereof, it is not intended to be limited thereto and various modifications can be made without departing from its spirit.

What is claimed is:

1. An environment migration system setting as a utilization environment of a terminal a utilization environment of another terminal in an information processing apparatus when the terminal utilizes the information processing apparatus through a network,
the another terminal comprising:
an address acquiring unit that reads storage information of a portable storage medium used by a person who will be a user of the terminal, the address acquiring unit acquiring an address of the information processing apparatus that is a destination of utilization allocation of the terminal included in the storage information to store the data of the address into a memory;
a connection establishing unit that transmits a connection establishment request including at least authentication information of the terminal or the user to the address of the information processing apparatus stored in the memory, the connection establishing unit executing a connection establishment process through a network between the information processing apparatus and the another terminal in accordance with response data returned from the information processing apparatus in response to the connection establishment request; and
a utilization environment transmitting unit that extracts data of the utilization environment of the another terminal in accordance with the execution of the connection establishment process to transmit the utilization environment data to the address of the information processing apparatus,
the information processing apparatus comprising:
a connection management table that stores the authentication information of the terminal or the user allocated to the information processing apparatus for utilization;
an establishment determining unit that receives the connection establishment request transmitted from the another terminal, the establishment determining unit checking the authentication information of the terminal or user included in the connection establishment request against the connection management table to determine whether the connection establishment request can be accepted, and the establishment determining unit sending back the determination result as response data to the another terminal; and
an environment setting unit that receives utilization environment data from the another terminal to store the utilization environment data into a storage apparatus as the utilization environment data of the terminal as the connection establishment process is executed for the another terminal in accordance with the determination result.

2. The environment migration system of claim 1, wherein
the another terminal includes
an authentication information acquiring unit that acquires the storage information of the portable storage medium, including an address of a management server executing a utilization allocation process between the terminal and the information processing apparatus, from a reader of the portable storage medium to store the information into an appropriate memory,
a utilization allocation request transmitting unit that includes and transmits the storage information of the portable storage medium read from the memory in a utilization allocation request for the information processing apparatus to the address of the management server read from the memory, and
an address storage processing unit that receives from the management server the address of the information processing apparatus that should be allocated to the terminal to store the address of the information processing apparatus into the portable storage medium, and wherein
the management server includes
an allocation management table that stores a correlation between the storage information of the portable storage medium used by each user of the terminal and the address of the information processing apparatus that is a destination of utilization allocation of the terminal linked to the portable storage medium, and
an address notifying unit that receives from the another terminal a utilization allocation request including the storage information of the portable storage medium, that checks the storage information of the portable storage medium included in the utilization allocation request against the allocation management table to identify the address of the information processing apparatus, and that supplies the address to the another terminal that is the source of the utilization allocation request.

3. The environment migration system of claim 1, wherein
the portable storage medium includes
an authentication information acquiring unit that acquires and stores the storage information of the portable storage medium into an appropriate memory of the portable storage medium itself or the another terminal,
a management server address storage unit that has stored thereon the address of the management server that executes a utilization allocation process between the terminal and the information processing apparatus,
a utilization allocation request transmitting unit that includes and transmits the storage information of the portable storage medium read from the memory in a utilization allocation request for the information processing apparatus to the address of the management server stored in the management server address storage unit through the another terminal, and
an address storage processing unit that receives the address of the information processing apparatus that should be allocated to the terminal transmitted from the management server to store the address of the information processing apparatus into the own appropriate memory of the portable storage medium, and wherein
the another terminal includes a transmitting/receiving unit that transmits output data of the utilization allocation request transmitting unit of the portable storage medium through the network to the management server and that sends back the address of the information processing apparatus sent from the management server to the address storage processing unit of the portable storage medium.

4. The environment migration system of claim 2, wherein
the portable storage medium includes
an authentication information acquiring unit that acquires and stores the storage information of the portable storage medium into an appropriate memory of the portable storage medium itself or the another terminal,
a management server address storage unit that has stored thereon the address of the management server that executes a utilization allocation process between the terminal and the information processing apparatus,
a utilization allocation request transmitting unit that includes and transmits the storage information of the portable storage medium read from the memory in a utilization allocation request for the information processing apparatus to the address of the management server stored in the management server address storage unit through the another terminal, and
an address storage processing unit that receives the address of the information processing apparatus that should be allocated to the terminal transmitted from the management server to store the address of the information processing apparatus into the own appropriate memory of the portable storage medium, and wherein
the another terminal includes a transmitting/receiving unit that transmits output data of the utilization allocation request transmitting unit of the portable storage medium through the network to the management server and that sends back the address of the information processing apparatus sent from the management server to the address storage processing unit of the portable storage medium.

5. The environment migration system of claim 1, wherein
the management server has a program stored in a storage apparatus including functions of the authentication information acquiring unit, the utilization allocation request transmitting unit, and the address storage processing unit, and wherein
the portable storage medium includes
the management server address storage unit,
a program acquisition requesting unit that extracts the address of the management server from the management server address storage unit to transmit an acquisition request for the program to this address, and
a program acquiring unit that downloads the program from the management server in accordance with the acquisition request for the program to store the program into a memory of the portable storage medium itself or the another terminal.

6. The environment migration system of claim 2, wherein
the management server has a program stored in a storage apparatus including functions of the authentication information acquiring unit, the utilization allocation request transmitting unit, and the address storage processing unit, and wherein
the portable storage medium includes
the management server address storage unit,
a program acquisition requesting unit that extracts the address of the management server from the management server address storage unit to transmit an acquisition request for the program to this address, and
a program acquiring unit that downloads the program from the management server in accordance with the acquisition request for the program to store the program into a memory of the portable storage medium itself or the another terminal.

7. The environment migration system of claim 3, wherein
the management server has a program stored in a storage apparatus including functions of the authentication information acquiring unit, the utilization allocation request transmitting unit, and the address storage processing unit, and wherein
the portable storage medium includes
the management server address storage unit,
a program acquisition requesting unit that extracts the address of the management server from the management server address storage unit to transmit an acquisition request for the program to this address, and
a program acquiring unit that downloads the program from the management server in accordance with the acquisition request for the program to store the program into a memory of the portable storage medium itself or the another terminal.

8. The environment migration system of claim 4, wherein
the management server has a program stored in a storage apparatus including functions of the authentication information acquiring unit, the utilization allocation request transmitting unit, and the address storage processing unit, and wherein
the portable storage medium includes
the management server address storage unit,
a program acquisition requesting unit that extracts the address of the management server from the management server address storage unit to transmit an acquisition request for the program to this address, and
a program acquiring unit that downloads the program from the management server in accordance with the acquisition request for the program to store the program into a memory of the portable storage medium itself or the another terminal.

9. The information processing system of claim 1, wherein
the information processing apparatus includes a biometrics authentication information storage unit that stores biometrics authentication information of a user of a terminal allocated to the information processing apparatus for utilization, and wherein
the establishment determining unit checks biological information of the user included in a connection establishment request received from the another terminal against the biometrics authentication information storage unit to determine whether the connection establishment request can be accepted and send back the determination result as response data to the another terminal.

10. The information processing system of claim 2, wherein
the information processing apparatus includes a biometrics authentication information storage unit that stores biometrics authentication information of a user of a terminal allocated to the information processing apparatus for utilization, and wherein
the establishment determining unit checks biological information of the user included in a connection establishment request received from the another terminal against the biometrics authentication information storage unit to determine whether the connection establishment request can be accepted and sends back the determination result as response data to the another terminal.

11. The information processing system of claim 3, wherein
the information processing apparatus includes a biometrics authentication information storage unit that stores biometrics authentication information of a user of a terminal allocated to the information processing apparatus for utilization, and wherein
the establishment determining unit checks biological information of the user included in a connection establishment request received from the another terminal against the biometrics authentication information storage unit to determine whether the connection establishment request can be accepted and sends back the determination result as response data to the another terminal.

12. The information processing system of claim 4, wherein
the information processing apparatus includes a biometrics authentication information storage unit that stores biometrics authentication information of a user of a terminal allocated to the information processing apparatus for utilization, and wherein
the establishment determining unit checks biological information of the user included in a connection establishment request received from the another terminal against the biometrics authentication information storage unit to determine whether the connection establishment request can be accepted and sends back the determination result as response data to the another terminal.

13. The information processing system of claim 5, wherein
the information processing apparatus includes a biometrics authentication information storage unit that stores biometrics authentication information of a user of a terminal allocated to the information processing apparatus for utilization, and wherein
the establishment determining unit checks biological information of the user included in a connection establishment request received from the another terminal against the biometrics authentication information storage unit to determine whether the connection establishment request can be accepted and sends back the determination result as response data to the another terminal.

14. The information processing system of claim 6, wherein
the information processing apparatus includes a biometrics authentication information storage unit that stores biometrics authentication information of a user of a terminal allocated to the information processing apparatus for utilization, and wherein
the establishment determining unit checks biological information of the user included in a connection establishment request received from the another terminal against the biometrics authentication information storage unit to determine whether the connection establishment request can be accepted and sends back the determination result as response data to the another terminal.

15. The information processing system of claim 7, wherein
the information processing apparatus includes a biometrics authentication information storage unit that stores biometrics authentication information of a user of a terminal allocated to the information processing apparatus for utilization, and wherein
the establishment determining unit checks biological information of the user included in a connection establishment request received from the another terminal against the biometrics authentication information storage unit to determine whether the connection establishment request can be accepted and sends back the determination result as response data to the another terminal.

16. The information processing system of claim 8, wherein
the information processing apparatus includes a biometrics authentication information storage unit that stores biometrics authentication information of a user of a terminal allocated to the information processing apparatus for utilization, and wherein
the establishment determining unit checks biological information of the user included in a connection establishment request received from the another terminal against the biometrics authentication information storage unit to determine whether the connection establishment request can be accepted and sends back the determination result as response data to the another terminal.

17. A terminal apparatus coupled to an information processing apparatus through a network to set its own utilization environment as a utilization environment of another terminal in the information processing apparatus, comprising:
an address acquiring unit that reads storage information of a portable storage medium used by a person who will be a user of the terminal, the address acquiring unit acquiring an address of the information processing apparatus that is a destination of utilization allocation of the terminal included in the storage information to store the data of the address into a memory;
a connection establishing unit that transmits a connection establishment request including at least authentication information of the terminal or the user to the address of the information processing apparatus stored in the memory, the connection establishing unit executing a connection establishment process through a network between the information processing apparatus and the terminal apparatus in accordance with response data returned from the information processing apparatus in response to the connection establishment request; and
a utilization environment transmitting unit that extracts data of the utilization environment of the terminal apparatus in accordance with the execution of the connection establishment process to transmit the utilization environment data to the address of the information processing apparatus.

18. An information processing apparatus that stores a utilization environment of a terminal apparatus coupled through a network as a utilization environment of another terminal, comprising:
a connection management table that stores authentication information of a terminal or user allocated to the information processing apparatus for utilization;
an establishment determining unit that receives a connection establishment request transmitted from the terminal apparatus, the establishment determining unit checking the authentication information of the terminal or user included in the connection establishment request against the connection management table to determine whether the connection establishment request can be accepted, and the establishment determining unit sending back the determination result as response data to the terminal apparatus; and
an environment setting unit that receives utilization environment data from the terminal apparatus to store the utilization environment data into a storage apparatus as the utilization environment data of the terminal as the connection establishment process is executed for the terminal apparatus in accordance with the determination result.

19. A management server coupled through a network to an information processing apparatus and a terminal apparatus using the apparatus, comprising:
an allocation management table that stores a correlation between the storage information of the portable storage medium used by each user of the terminal and the address of the information processing apparatus that is a destination of utilization allocation of the terminal linked to the portable storage medium; and
an address notifying unit that receives from the terminal apparatus a utilization allocation request including the storage information of the portable storage medium, the address notifying unit checking the storage information of the portable storage medium included in the utilization allocation request against the allocation management table to identify the address of the information processing apparatus, and the address notifying unit supplying the address to the terminal apparatus that is the source of the utilization allocation request.

20. A portable storage medium coupled to an information processing apparatus through a terminal apparatus to set a utilization environment of the terminal apparatus as a utilization environment of another terminal in an information processing apparatus, comprising:
an authentication information acquiring unit that acquires and stores the storage information of the portable storage medium into an appropriate memory of the portable storage medium itself or the terminal apparatus;
a management server address storage unit that has stored thereon an address of a management server that executes a utilization allocation process between the terminal and the information processing apparatus;
a utilization allocation request transmitting unit that includes and transmits the storage information of the portable storage medium read from the memory in a utilization allocation request for the information processing apparatus to the address of the management server stored in the management server address storage unit; and
an address storage processing unit that receives an address of the information processing apparatus that should be allocated to the terminal from the management server to store the address of the information processing apparatus into the own appropriate memory of the portable storage medium.
